(19) United States
(12) Patent Application Publication
(10) Pub. No.: US 2026/0312844 A1
(43) Pub. Date: Oct. 8, 2026

(54) DIFFERENTIAL ENVELOPE DETECTOR CIRCUIT WITH COMMON MODE NOISE SUPPRESSION

(71) Applicant: Infineon Technologies AG, Neubiberg (DE)

(72) Inventor: Marcus Nuebling, Olching-Esting (DE)

(21) Appl. No.: 19/169,586

(22) Filed: Apr. 3, 2025

(51) Int. Cl. H04L 25/02

(52) U.S. Cl. CPC H04L 25/0276; H04L 25/0266

(57) ABSTRACT

In some examples, a differential envelope detector circuit comprises a differential transconductance circuit configured to receive a first voltage signal of a differential signal and a second voltage signal of the differential signal and generate a first output current signal based on the first voltage signal and a second voltage signal, a common mode detection circuit configured to generate a common mode current signal indicative of common mode noise present in the first voltage signal and the second voltage signal of the differential signal, and a summation circuit configured to generate a second output current signal by removing the common mode current signal from the first output current signal.

### TECHNICAL FIELD

This disclosure relates to differential envelope detector circuits, such as those used in receiver circuits configured to receive differentially coded data over a galvanic isolation barrier.

### BACKGROUND

Differential envelope detector circuits are used for data communication between circuits. As one example, differential envelope detector circuits may be used for decoding information that is encoded using ON-OFF shift Keying (OOK) with a differential carrier signal. In OOK and other coding techniques, envelope detector circuits are desirable to decode information from one or more encoded signals. OOK is useful in many situations because of high noise immunity to common mode noise. One useful application of OOK with a differential carrier is data communication over galvanic isolation barriers, e.g., to communicate information between different voltage domains.

Galvanic isolation may be used in electronic devices to separate two voltage domains inside of a circuit package. As one example, a microcontroller may generate and deliver control signals to a low-side gate driver and a high-side gate driver for controlling low-side and high-side power switches arranged in a half-bridge circuit. Galvanic isolation may be desirable to ensure that the microcontroller is protected from a high voltage domain associated with one or both of the gate drivers. The microcontroller and one or both of the gate drivers may be configured to operate in different power domains.

Gate drivers for power switches is just one example where galvanic isolation is used, but galvanic isolation may also be used for many other purposes and applications. In general, when galvanic isolation is desirable, circuit packages can be defined with two different circuits that are galvanically isolated. Communicating data across the galvanic isolation barrier, e.g., within a circuit package, may be desirable to facilitate circuit control or for other reasons.

### SUMMARY

This disclosure describes differential envelope detector circuits and methods of operating differential envelope detector circuits. This disclosure also describes devices that include two circuits separated by a galvanic isolation barrier, which may use a differential envelope detector circuit for decoding information communicated over the galvanic isolation barrier.

In some examples, this disclosure describes a device arranged to include a galvanic isolation barrier between a first voltage domain and a second voltage domain. The device may comprise a transmitter circuit in the first voltage domain, and a receiver circuit in the second voltage domain. The receiver circuit may include a differential envelope detector circuit comprising: a differential transconductance circuit configured to receive a first voltage signal of a differential signal and a second voltage signal of the differential signal and generate a first output current signal based on the first voltage signal and a second voltage signal, a common mode detection circuit configured to generate a common mode current signal indicative of common mode noise present in the first voltage signal and the second voltage signal of the differential signal, and a summation circuit configured to generate a second output current signal by removing the common mode current signal from the first output current signal.

In some examples, this disclosure describes a differential envelope detector circuit that comprises a differential transconductance circuit configured to receive a first voltage signal of a differential signal and a second voltage signal of the differential signal and generate a first output current signal based on the first voltage signal and a second voltage signal, a common mode detection circuit configured to generate a common mode current signal indicative of common mode noise present in the first voltage signal and the second voltage signal of the differential signal, and a summation circuit configured to generate a second output current signal by removing the common mode current signal from the first output current signal.

In some examples, this disclosure describes a method performed by an envelope detector circuit. The method may comprise receiving, at a differential transconductance circuit, a first voltage signal and a second voltage signal, wherein the first voltage signal an the second voltage signal define a differential signal; generating, via the differential transconductance circuit, a first output current signal based on the first voltage signal and a second voltage signal; generating, via a common mode detection circuit, a common mode current signal indicative of common mode noise present in the first voltage signal and the second voltage signal; and generating, via a summation circuit, a second output current signal by removing the common mode current signal from the first output current signal.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram of a device consistent with this disclosure.

FIGS. 2A and 2B are conceptual illustrations of example circuit package devices consistent with FIG. 1 and this disclosure.

FIG. 3 a set of graphs showing one example of differential coding using ON-OFF shift Keying (OOK) with a differential carrier signal.

FIG. 4 is a block diagram showing an example of a differential envelope detector circuit that may be used in the device of FIG. 1 or in other devices or circuits.

FIG. 5 is another set of graphs showing differential signals and decoding consistent with this disclosure.

FIG. 6 is a circuit diagram showing one example device with a differential envelope detector circuit consistent with this disclosure.

FIG. 7 is a flow diagram consistent with one or more examples of this disclosure.

### DETAILED DESCRIPTION

This disclosure describes differential envelope detector circuits and methods of operating differential envelope detector circuits. This disclosure also describes devices that include two circuits separated by a galvanic isolation barrier, which may use a differential envelope detector circuit for decoding information communicated over the galvanic isolation barrier.

Devices with galvanic isolation are increasingly demanded in larger devices or systems, such as in electric vehicles. The galvanic isolation needs to have a very high level of robustness, while allowing for data communication across the galvanic isolation barrier. For this, circuits may be configured to perform differential coding using ON-OFF shift Keying (OOK) with a differential carrier signal. OOK with a differential carrier signal is desirable because it has relatively high common mode transient immunity (CMTI).

In addition to high CMTI, however, common mode immunity to electromagnetic noise is also desirable for modern devices or systems, such as in electric vehicles. Electromagnetic-Noise-Injection tests may be performed on devices or systems to measure common mode immunity beyond CMTI. Electromagnetic-Noise-Injection tests on a system level are sometimes performed up to 6 gigahertz (GHz). At such high frequencies, circuits that communicate using OOK with a differential carrier signal may not achieve sufficient common mode immunities needed for some devices or systems. In one or more examples of this disclosure, the described circuits and techniques may address these problems and may achieve common mode immunity to electromagnetic noise up to or above 6 GHz. In some examples, the described circuits and techniques of this disclosure can achieve significant improvements to CMTI suppression within a frequency range of 1 GHz to 6 GHz.

Galvanic isolation of circuits can be achieved by using a transformer (e.g., a coreless transformer) or other isolation elements (e.g., capacitors) to galvanically isolate a low voltage domain of a first circuit from a high voltage domain of a second circuit. In some examples, this disclosure describes circuit package devices and techniques for communicating data within circuit package devices. In particular, this disclosure describes techniques for communicating over a galvanic isolation barrier that is formed between two different circuits within a circuit package. In order to achieve improved common mode immunities, this disclosure further describes improvements to envelope detector circuits, which may be used on the receiving side of communication over a galvanic isolation barrier. In some examples, the described envelope detector circuits may also be used in other systems or devices, including communication systems that do not have galvanic isolation.

In some examples, when galvanic isolation is used, the first and second circuits may be embedded in a molding material within the circuit package and the first and second circuits may be mechanically separated from one another within the circuit package by less than 5 millimeters, less than 3 millimeters, or less than one millimeter. The galvanic isolation barrier may be achieved using one or more inductors and/or one or more capacitors. The one or more inductors and/or one or more capacitors that define the galvanic isolation may also form the communication channel for communicating data between the two different circuits within the circuit package.

The communication channel between the first circuit and the second circuit across the galvanic isolation barrier may comprise a differential communication channel. According to this disclosure, in some examples, the first circuit and the second circuit may be configured to code the data across the differential communication channel using ON-OFF shift Keying (OOK) with a differential carrier signal.

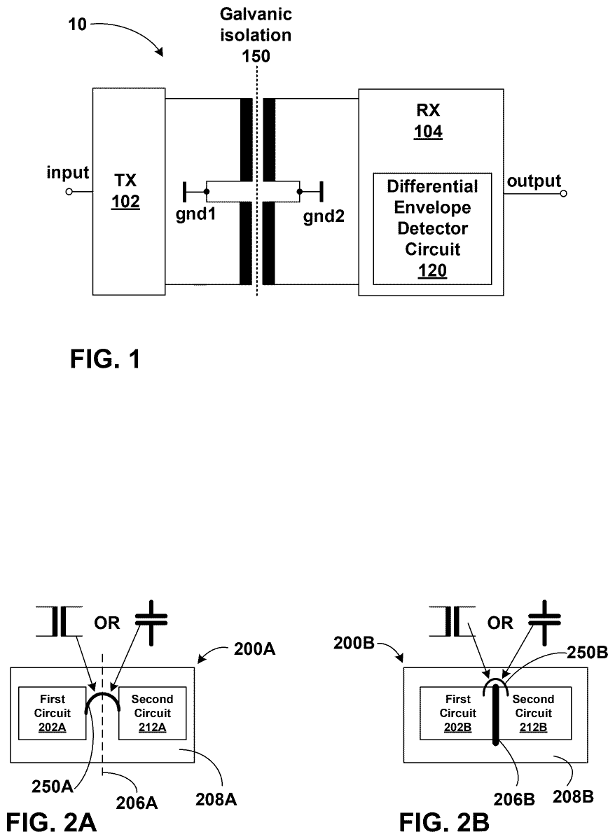

FIG. 1 is block diagram of a device 10 consistent with one or more examples of this disclosure. Device 10 is arranged to include a galvanic isolation barrier 150 between a first voltage domain (e.g., on the left of barrier 150) and a second voltage domain (on the right of barrier 150). Device 10 comprises a transmitter circuit 102 in the first voltage domain and a receiver circuit 104 in the second voltage domain. According to some examples of this disclosure, receiver circuit 104 includes a differential envelope detector circuit 120 configured to remove common mode noise from received differential signals. As described in examples below, differential envelope detector circuit 120 may comprise a differential transconductance circuit configured to receive a first voltage signal of a differential signal and a second voltage signal of the differential signal and generate a first output current signal based on the first voltage signal and a second voltage signal. Differential envelope detector circuit 120 may also include a common mode detection circuit configured to generate a common mode current signal indicative of common mode noise present in the first voltage signal and the second voltage signal of the differential signal. In addition, differential envelope detector circuit 120 may include a summation circuit configured to generate a second output current signal by removing the common mode current signal from the first output current signal. Additional circuit details and examples that may be used in differential envelope detector circuit 120 are set forth below.

FIG. 2A is a conceptual cross-sectional side view of a device that comprises a circuit package 200A. Circuit package 200A comprises a first circuit 202A that is configured to operate in a first voltage domain and a second circuit 212A that is configured to operate in a second voltage domain. The first voltage domain is different than the second voltage domain. For example, the first voltage domain may comprise a low voltage domain that is less than 40 volts and the second voltage domain may comprise a high voltage domain that is greater than 100 volts. In the example of FIG. 2A, first circuit 202A and second circuit 212A are formed on different circuit dies and device 200A includes a molding compound 208A formed around the different circuit dies of first circuit 202A and second circuit 212A.

In circuit package 200A, one or more isolation elements (e.g., inductor(s) or capacitor(s)) may configured to define the galvanic isolation barrier 206A between a first voltage domain and a second voltage domain. This is shown conceptually by the illustration of the inductor symbol and the capacitor symbol in FIG. 2A. Inductors, for example, may be arranged to define a transformer, such as a coreless transformer. The one or more isolation elements (e.g., inductor(s) or capacitor(s)) may also define a differential communication channel 250A that is configured to communicate data between first circuit 202A and second circuit 212A across the galvanic isolation barrier 206A. In some examples, grounded guard bands may surround the isolation elements, and in some examples, a grounded guard band may also surround circuit 202A that operates in the low voltage domain. The grounded guard bands (not shown) may improve the galvanic isolation between the two different circuits. Molding material 208A (such as a molding compound) may encapsulate circuits 202A, 212A so as to define circuit package 200A. Other devices or circuits may connect to circuit package 200A via external conductors (not shown) that provide electrical access to circuits 202A, 212A through molding material 208A.

As described in greater detail below, first circuit 202A and second circuit 212A may be configured to communicate coded the data across differential communication channel 250A within circuit package 200A using differential coding techniques. Moreover, second circuit 212A may include an envelope detector, as described herein, to achieve improved common mode noise immunity.

FIG. 2B is a conceptual cross-sectional side view of a device 200B that comprises a circuit package 200B. Circuit package 200B of FIG. 2B is very similar to circuit package 200A of FIG. 2A in many respects. Circuit package 200B comprises a first circuit 202B that is configured to operate in a first voltage domain and a second circuit 212B that is configured to operate in a second voltage domain. The first voltage domain is different than the second voltage domain. Again, for example, the first voltage domain may comprise a low voltage domain that is less than 40 volts and the second voltage domain may comprise a high voltage domain that is greater than 100 volts. In the example of FIG. 2B, first circuit 202B and second circuit 212B are formed on a same circuit die during a semiconductor manufacturing process with a trench 206B formed in the circuit die. Trench 206 may galvanically isolate the first voltage domain from the second voltage domain. Device 200B may include a molding material (such as a molding compound) formed around the common circuit die that includes first circuit 202B and second circuit 212B.

One or more external conductors may be electrically connected to first circuit 202B and second circuit 212B. An insulator material may be formed over the common circuit die. In circuit package 200B, one or more isolation elements (e.g., inductor(s) or capacitor(s) as illustrated by the inductor and capacitor symbols) may be configured to define the galvanic isolation barrier between a first voltage domain and a second voltage domain, which are separated by trench 206B. The one or more isolation elements (e.g., inductor(s) or capacitor(s)) also define a differential communication channel 250B that is configured to communicate data between first circuit 202B and second circuit 212B across the galvanic isolation barrier defined by trench 206B. In some examples, grounded guard bands may surround the isolation elements, and in some examples, a grounded guard band may also surround one or both of circuits 202B, 212B. A molding material 208B may encapsulate circuits 202B, 212B so as to define circuit package 200B. Other devices or circuits may connect to circuit package 200B via external conductors (not shown) that provide electrical access to first circuit 202B and second circuit 212B through molding material 208A.

As with the example shown in FIG. 2A, in FIG. 2B second circuit 212B may include an envelope detector, as described herein, to achieve improved common mode noise immunity. Referring to both FIGS. 2A and 2B, in various examples, the first circuit 202A, 202B may operate in a low voltage domain, such as a voltage domain associated with a microcontroller, e.g., 5 volts, 3.3 volts, or another voltage typically used for low voltage microcontrollers. The second circuit 212A, 212B may operate in a high voltage domain, such as a voltage domain associated with a high voltage power switch, e.g., 400-6000 volts associated with an insulated-gate bipolar transistor (IGBT), 600-1200 volts associated with a silicon carbide (SiC) metal oxide semiconductor field effect transistor (MOSFET), 600-1200 volts associated with a gallium nitride (GaN) field effect transistor (FET), or even higher voltages associated with a gate turn on (GTO) thyristor, another type of thyristor, or another type of power switch.

In still other examples, the techniques and circuits of this disclosure may be used in any circuit package device where communication over a galvanic isolation barrier is performed within the circuit package device. Galvanic isolation may be desirable for controlling various type of field-effect transistors (FETs) including any one or combination of a metal-oxide-semiconductor field-effect transistor (MOSFET), a bipolar junction transistor (BJT), an insulated-gate bipolar transistor (IGBT), a junction field effect transistor (JFET), a high electron mobility transistor (HEMT), or other kinds of elements that use voltage or current for control. Such transistors may be formed in various material compounds, such as Silicon, Silicon Carbide, Gallium Nitride, or any other combination of one or more semiconductor materials. In some examples, silicon carbide switches may experience lower switching power losses. Improvements in magnetics and faster switching, such as Gallium Nitride switches, may allow a power transistor to draw short bursts of current. These higher frequency devices may require control signals (e.g., voltage signals delivered to the control terminal of the power transistor) to be sent with more precise timing, as compared to lower-frequency devices.

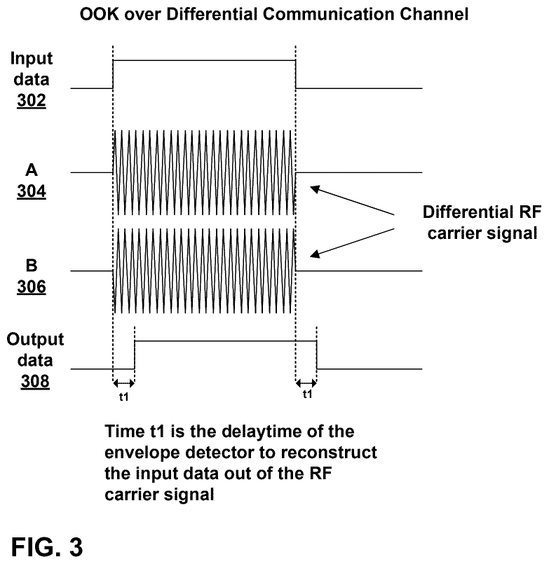

FIG. 3 is a set of graphs showing differential OOK, consistent with this disclosure. Consistent with FIG. 3, OOK refers to a form of amplitude-shift keying (ASK) modulation that represents digital data (e.g., the input data 302 shown FIG. 3) as the presence or absence of a carrier wave (e.g., shown as “A” 304 and “B” 306 in FIG. 3). With differential OOK, the carrier wave “A” may be phase shifted relative to carrier wave “B.” The differential carrier wave data (e.g., A and B in FIG. 3) can be sent from transmitter circuit 102 and received by receiver circuit 104 and then decoded to generate the output data shown in FIG. 3. The output data may represent a binary bit similar to the input data, with time t1 representing the delay time needed, e.g., by an envelope detector circuit, to reconstruct the data based on the differential carrier wave data (e.g., A and B in FIG. 3). This disclosure describes improvements to an envelope detector circuit that may be useful in these applications or other applications.

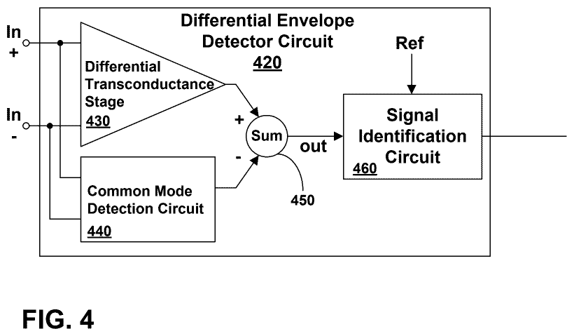

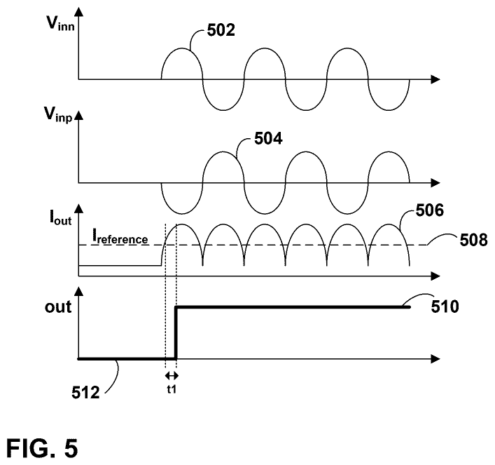

FIG. 4 is a block diagram showing an example of a differential envelope detector circuit 420 that may be used in the device of FIG. 1, second circuit 212A of FIG. 2A, second circuit 212B of FIG. 2B, or in other devices or circuits. As shown in FIG. 4, differential envelope detector circuit 420 comprises a differential transconductance circuit 430, which may comprise a gain stage (also called a differential transconductance stage). Differential envelope detector circuit 420 may be configured to receive a first voltage signal (In+) of a differential signal and a second voltage signal (In−) of the differential signal and generate a first output current signal based on the first voltage signal and a second voltage signal. Differential transconductance circuit 430 may comprise a transconductance amplifier used as an active rectifier. For example, as shown in FIG. 5, differential transconductance circuit 430 may receive a first voltage signal (In+) corresponding to signal 502 in FIG. 5 and a second voltage signal (In−) corresponding to signal 504 in FIG. 5. Differential transconductance circuit 430 outputs a rectified signal corresponding to signal 506 of FIG. 5. According to this disclosure, differential envelope detector circuit 420 may be configured to remove common noise from signal 506, i.e., noise present in both first input signal 502 and second input signal 504.

Differential envelope detector circuit 420 includes a common mode detection circuit 440 configured to generate a common mode current signal indicative of common mode noise present in the first voltage signal (In+) and the second voltage signal (In−) of the differential signal and a summation circuit 450 configured to generate a second output current signal by removing the common mode current signal from the first output current signal. A signal identification circuit 460 may be configured to determine a high state or a low state associated with the second output current signal. In particular, for example, signal identification circuit 460 may be configured to output a logic signal 510 (logic high) in response to output current signal 506 exceeding a threshold (I_{reference}) 508. Similarly, a logic low signal 512 may be output in the situation where output current signal 506 does not exceed the threshold (I_{reference}) 508. The time “t1” shown in FIG. 5 may correspond to the delay time for differential envelope detector circuit 420 from receiving its input voltage signals to output of the logic signal 510. The threshold (I_{reference}) 508 may correspond to “Ref” shown in FIG. 4.

In various examples, signal identification circuit 460 may be realized using a capacitor, a capacitor and a comparator, a Schmidt trigger, and analog-to-digital converter (ADC) or other circuit elements. In the more detailed circuit example described below, a current mirror and a capacitor may be arranged used to realize summation circuit 450 to remove the common mode current noise signal the output of differential transconductance circuit 430, which can improve the ability of signal identification circuit 460 to accurately identify whether a differential signal corresponds to logic high or logic low.

In some examples, differential transconductance circuit 430 may comprise two half-bridge circuits, i.e., a first high side transistor and a first low side transistor arranged in a first half-bridge; and a second high side transistor and a second low side transistor arranged in a second half-bridge. The two voltage signals of the differential signal can be routed to the high side and low side in a complementary fashion. That is to say, the first high side transistor and the second low side transistor can be configured to receive the first voltage signal of the differential signal, and the second high side transistor and the first low side transistor can be configured to receive the second voltage signal of the differential signal. In this case, common mode detection circuit 440 may comprise a third high side transistor and a third low side transistor arranged in a third half-bridge and both connected to a circuit node that receives both the first voltage signal and the second voltage signal of the differential signal. The circuit node that receives both the first voltage signal and the second voltage signal of the differential signal may be a node that positioned between two resistors that electorally connect to inputs of the first voltage signal (In+) and the second voltage signal (In−) of the differential signal.

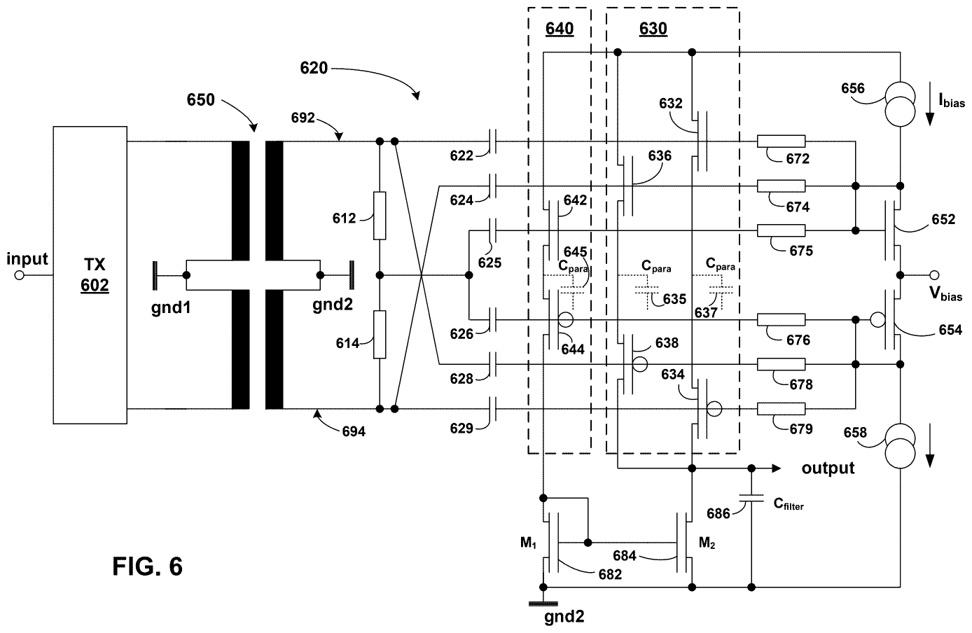

The first low side transistor may have an inverted input relative to the first high side transistor, the second low side transistor may have an inverted input relative to the second high side transistor, and the third low side transistor may have an inverted input relative to the third high side transistor. As half-bridge circuits, an output of the first high side transistor may be connected to an input of the first low side transistor forming the first half bridge, an output of the second high side transistor may be connected to an input of the second low side transistor forming the second half-bridge, and an output of the third high side transistor may be connected to an input of the third low side transistor forming the third half bridge. FIG. 6 provides an example circuit consistent with many aspects of the description of FIG. 4 above.

FIG. 6 is a circuit diagram of a device consistent with one or more examples of this disclosure. The device of FIG. 6 is arranged to include a galvanic isolation barrier 650 between a first voltage domain (e.g., on the left of barrier 650) and a second voltage domain (on the right of barrier 650). The device of FIG. 6 comprises a transmitter circuit 602 in the first voltage domain and an envelope detector circuit 620 in the second voltage domain. In some examples, envelope detector circuit 620 may comprise a front end portion of a larger receiver circuit. The arrangement of circuit elements shown in FIG. 6 is one example way to implement a differential envelope detector circuit that is configured to remove common mode noise from received differential signals.

As shown in FIG. 6 differential voltage signals may be received on input lines 692, 694. In particular, a first voltage signal is received by receiver circuit on line 692 and a second voltage signal is received by receiver circuit on line 694. The first voltage signal and the second voltage signal define a differential signal.

Elements 630 may define a portion of a differential transconductance circuit that receives the first voltage signal and the second voltage signal on lines 692, 694. Differential envelope detector circuit 620 includes a common mode detection circuit, which may be realized by half bridge 640, transistors M1 and M2 682, 684 and capacitor 686, along with corresponding input capacitors 625, 626 and output resistors 675, 676 associated with transistors 642, 644 of half bridge 640.

A differential transconductance circuit may comprise two half bridge circuits within elements 630. An output of a first high side transistor 632 is connected to an input of a first low side transistor 634 to define a first half bridge. Similarly, an output of a second high side transistor 636 is connected to an input of a second low side transistor 644 to define a second half bridge.

The two voltage signals of the differential signal (e.g., on lines 692, 694) can be routed to the high side and low side in a complementary fashion. That is to say, first high side transistor 632 and second low side transistor 638 are configured to receive the first voltage signal of the differential signal, and second high side transistor 636 and first low side transistor 634 be configured to receive the second voltage signal of the differential signal. Capacitors 622, 624, 628, 629 and resistors 672, 674, 678, 679 are arranged to properly control the voltage signals applied to the control terminals (e.g., the gates) of transistors 632, 636, 638, 634 and transistors 652, 654 so as to realize a transconductance circuit. Current sources 656, 658 provide current source and sink through transistors 652, 654. A voltage bias (“Vbias”) may be set or controlled at the node between transistors 652, 654. Capacitors 622, 624, 628, 629 may operate as high pass filters, removing low frequency common mode noise. Thus, in some examples, capacitors 622, 624, 628, 629 may define a first common mode filter of envelope detector circuit 620 and the common mode detection circuit portion (described below) of envelope detector circuit 620 may define a second common mode filter. In this case, the first filter defined by capacitors 622, 624, 628, 629 may define a low frequency filter of envelope detector circuit 620 and the common mode detection circuit portion of envelope detector circuit 620 may define a high frequency filter.

The first half bridge defined by transistors 632, 634 defines a first parasitic capacitance 637, and the second half bridge defined by transistors 636, 638 defines second parasitic capacitance 635. To some extent, the existence of parasitic capacitances 637, 635 may contribute to the issues and the high frequency common mode noise problems solved by the techniques and circuits of this disclosure.

Again, differential envelope detector circuit 620 includes a common mode detection circuit, which may be realized by half bridge 640 (hereafter the third half bridge), transistors M1 and M2 682, 684 and capacitor 686, along with corresponding input capacitors 625, 626 and output resistors 675, 676 associated with transistors 642, 644 of third half bridge 640.

Third half bridge 640 comprises a third high side transistor 642 and a third low side transistor 644 arranged in half-bridge and both connected to a circuit node that receives both the first voltage signal and the second voltage signal of the differential signal. In this case, the circuit node that receives both the first voltage signal and the second voltage signal of the differential signal may be the node positioned between resistors 612, 614, which electrically connects to inputs of the first voltage signal on line 692 and the second voltage signal on line 694. Third high side transistor 642 and a third low side transistor 644 create a third parasitic capacitance 645, which may be configured to be the same as first parasitic capacitance 637 and second parasitic capacitance 635.

To achieve complementary operation of the first, second, and third half bridges in envelope detector circuit 620, first low side transistor 634 may have an inverted input relative to first high side transistor 632, second low side transistor 638 may have an inverted input relative to the second high side transistor 636, and third low side transistor 644 may have an inverted input relative to third high side transistor 642. Third half bridge 640 generates a common mode current signal indicative of common mode noise present in the first voltage signal (on line 692) and the second voltage signal (on line 694) of the differential signal. Transistors 682, 684 and capacitor 686 may define a summation circuit configured to generate a second output current signal (the “output”) by removing the common mode current signal from the first output current signal (i.e., the current flowing through two half bridge circuits within elements 630).

Capacitor 686 may be connected to the first output current signal (e.g., the first output current signal that is output of the two half bridge circuits within elements 630). Capacitor 686 may store an indication of the mirror of the common mode current signal generated by the common mode detection circuit described herein. The common mode current signal may flow though M1 transistor 682 to ground, and a mirror of that common mode current signal flows from capacitor 686 through M2 transistor 684 to ground. With this arrangement, the common mode current signal is caused to be removed from the first current signal at the output node (“output” in FIG. 6) of envelope detector circuit 620. The output in FIG. 6 is therefore second current signal defined as the first current signal (from elements 630) minus the common mode current signal (output from half bridge 640).

A signal identification circuit (not shown in FIG. 6) can then be configured to determine a high state or a low state associated with the second output current signal. In particular, referring again to FIG. 5 for example, a signal identification circuit may be configured to output a logic signal 510 (logic high) in response to output current signal 506 exceeding a threshold (I_{reference}) 508. Similarly, a logic low signal 512 may be output in the situation where output current signal 506 does not exceed the threshold (I_{reference}) 508. Again, the time “t1” shown in FIG. 5 may correspond to the delay time for the differential envelope detector circuit from receiving its input voltage signals to output of the logic signal 510. The threshold (I_{reference}) 508 may be defined in a number of ways or may be predefined. In some examples, threshold (I_{reference}) 508 correspond to “Ref” shown in FIG. 4.

A signal identification circuit (not shown in FIG. 6) may be connected to the “output” and realized using an additional capacitor, an additional capacitor and a comparator, a Schmidt trigger, an analog-to-digital converter (ADC), or other circuit elements.

In contrast to circuits, the circuits described herein can be viewed as common mode detection circuit with a specific portion of the circuit (e.g., half bridge 640) that replicates the common mode transfer function of the gain stage (e.g., elements 630 that include two half bridges). Then the output of the replica (e.g., half bridge 640) is subtracted from the overall transfer function of the gain stage (e.g., elements 630 that include two half bridges) which may completely or substantially eliminate the common mode signal from the output.

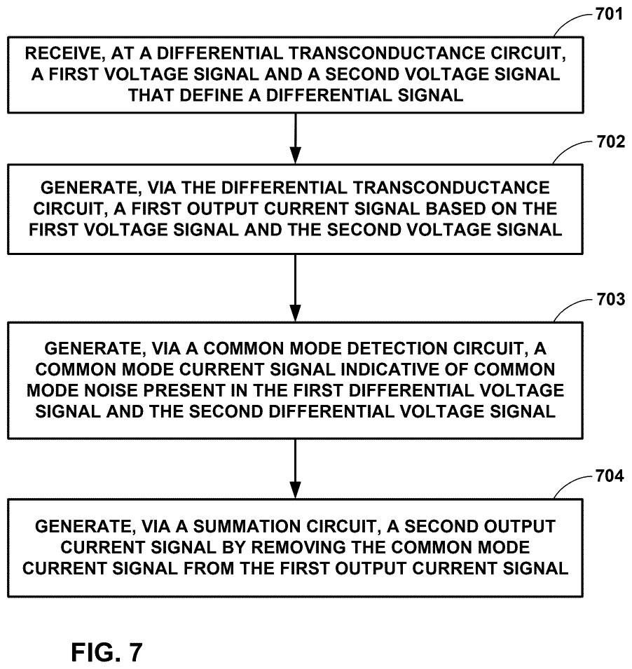

FIG. 7 is a flow diagram consistent with one or more examples of this disclosure. FIG. 7 will be described from the perspective of differential envelope detector circuit 420 of FIG. 4, although other circuits could implement the techniques shown in FIG. 7.

As shown in FIG. 7, differential transconductance stage 430 (i.e., a differential transconductance circuit) receives a first voltage signal (In+) and a second voltage signal (IN−) that define a differential signal (701). Differential transconductance stage 430 generates a first output current signal based on the first voltage signal and the second voltage signal (702). Meanwhile, common mode detection circuit 440 generates a common mode current signal indicative of common mode noise present in the first voltage signal (In+) and a second voltage signal (IN−). Summation circuit 450 remove the common mode current signal from the first output current signal to generate a second output current signal (labeled “OUT” in FIG. 4). Signal identification circuit 460 can then determine a high state or a low state associated with the second output current signal, and because of the removal of common mode noise the performance of signal identification circuit 460 may improve relative to conventional circuits.

The techniques described in this disclosure may be implemented, at least in part, in circuitry, hardware, software, firmware or any combination thereof. Such hardware, software, and firmware may be implemented within the same device or within separate devices to support the various operations and functions described in this disclosure. In addition, any of the described units, modules or components may be implemented together or separately as discrete but interoperable circuits or devices. Depiction of different features as modules or units is intended to highlight different functional aspects and does not necessarily imply that such modules or units must be realized by separate components. Rather, functionality associated with one or more modules or units may be performed by separate components or circuits or integrated within common components or circuits. It may also be possible for one or more aspects of this disclosure to be performed in software, in which case those aspects of the techniques described in this disclosure may also be embodied or encoded in a computer-readable medium.

The following numbered aspects demonstrate one or more aspects of the disclosure.

Clause 1—A device arranged to include a galvanic isolation barrier between a first voltage domain and a second voltage domain, the device comprising: a transmitter circuit in the first voltage domain; and a receiver circuit in the second voltage domain, wherein the receiver circuit includes a differential envelope detector circuit comprising: a differential transconductance circuit configured to receive a first voltage signal of a differential signal and a second voltage signal of the differential signal and generate a first output current signal based on the first voltage signal and a second voltage signal, a common mode detection circuit configured to generate a common mode current signal indicative of common mode noise present in the first voltage signal and the second voltage signal of the differential signal, and a summation circuit configured to generate a second output current signal by removing the common mode current signal from the first output current signal.

Clause 2—The device of clause 1, wherein the first circuit and the second circuit are formed on different circuit dies and the device includes a molding compound formed around the different circuit dies.

Clause 3—The device of clause 1 or 2, wherein the first circuit and the second circuit are formed on a same circuit die during a semiconductor manufacturing process with a trench formed in the circuit die to isolate the first voltage domain from the second voltage domain, and wherein the device includes a molding compound formed around the circuit die.

Clause 4—The device of any of clauses 1-3, wherein the galvanic isolation barrier is formed via a coreless transformer that galvanically isolates the first voltage domain and the second voltage domain.

Clause 5—The device of any of clauses 1-4, wherein the galvanic isolation barrier is formed via one or more capacitors that galvanically isolates the first voltage domain and the second voltage domain.

Clause 6—The device of any of clauses 1-5, wherein the differential envelope detector circuit further comprises a signal identification circuit configured to determine a high state or a low state associated with the second output current signal.

Clause 7—The device of any of clauses 1-6, wherein the differential transconductance circuit comprises: a first high side transistor and a second low side transistor configured to receive the first voltage signal of the differential signal; and a second high side transistor and a first low side transistor configured to receive the second voltage signal of the differential signal, and wherein the common mode detection circuit comprises a third high side transistor and a third low side transistor both connected to a circuit node that receives both the first voltage signal and the second voltage signal of the differential signal.

Clause 8—The device of clause 7, wherein the circuit node is positioned between two resistors that electorally connect to inputs of the first voltage signal and the second voltage signal of the differential signal.

Clause 9—The device of any of clauses 1-8, wherein the summation circuit comprises: a current mirror circuit configured to generate a mirror of the common mode current signal; and a capacitor connected to the first output current signal and configured to form a subtraction node that causes the common mode current signal to be removed from the first output current signal and to store an output voltage signal indicative of the second output current signal.

Clause 10—The device of any of clauses 7-9, wherein the first low side transistor has an inverted input relative to the first high side transistor, wherein the second low side transistor has an inverted input relative to the second high side transistor, and wherein the third low side transistor has an inverted input relative to the third high side transistor.

Clause 11—The device of any of clauses 7-10, wherein an output of the first high side transistor is connected to an input of the first low side transistor, wherein an output of the second high side transistor is connected to an input of the second low side transistor, and wherein an output of the third high side transistor is connected to an input of the third low side transistor.

Clause 12—A differential envelope detector circuit comprising: a differential transconductance circuit configured to receive a first voltage signal of a differential signal and a second voltage signal of the differential signal and generate a first output current signal based on the first voltage signal and a second voltage signal, a common mode detection circuit configured to generate a common mode current signal indicative of common mode noise present in the first voltage signal and the second voltage signal of the differential signal, and a summation circuit configured to generate a second output current signal by removing the common mode current signal from the first output current signal.

Clause 13—The differential envelope detector circuit of clause 12, further comprising a signal identification circuit configured to determine a high state or a low state associated with the second output current signal.

Clause 14—The differential envelope detector circuit of clause 12 or 13, wherein the differential transconductance circuit comprises: a first high side transistor and a second low side transistor configured to receive the first voltage signal of the differential signal; and a second high side transistor and a first low side transistor configured to receive the second voltage signal of the differential signal, and wherein the common mode detection circuit comprises a third high side transistor and a third low side transistor both connected to a circuit node that receives both the first voltage signal and the second voltage signal of the differential signal.

Clause 15—The differential envelope detector circuit of clause 14, wherein the circuit node is positioned between two resistors that electorally connect to inputs of the first voltage signal and the second voltage signal of the differential signal.

Clause 16—The differential envelope detector circuit of any of clauses 12-15, wherein the summation circuit comprises: a current mirror circuit configured to generate a mirror of the common mode current signal; and a capacitor connected to the first output current signal and configured to form a subtraction node that causes the common mode current signal to be removed from the first output current signal and to store an output voltage signal indicative of the second output current signal.

Clause 17—The differential envelope detector circuit of any of clauses 14-16, wherein the first low side transistor has an inverted input relative to the first high side transistor, wherein the second low side transistor has an inverted input relative to the second high side transistor, and wherein the third low side transistor has an inverted input relative to the third high side transistor.

The differential envelope detector circuit of any of clauses 14-17, wherein an output of the first high side transistor is connected to an input of the first low side transistor, wherein an output of the second high side transistor is connected to an input of the second low side transistor, and wherein an output of the third high side transistor is connected to an input of the third low side transistor.

Clause 19—A method performed by an envelope detector circuit, the method comprising: receiving, at a differential transconductance circuit, a first voltage signal and a second voltage signal, wherein the first voltage signal an the second voltage signal define a differential signal; generating, via the differential transconductance circuit, a first output current signal based on the first voltage signal and a second voltage signal; generating, via a common mode detection circuit, a common mode current signal indicative of common mode noise present in the first voltage signal and the second voltage signal; and generating, via a summation circuit, a second output current signal by removing the common mode current signal from the first output current signal.

Clause 20—The method of clause 19, further comprising: determining a high state or a low state associated with the second output current signal.

Various examples of the disclosure have been described. Any combination of the described systems, operations, or functions is contemplated. These and other examples are within the scope of the following claims.

What is claimed is:

1. A device arranged to include a galvanic isolation barrier between a first voltage domain and a second voltage domain, the device comprising:
a transmitter circuit in the first voltage domain; and
a receiver circuit in the second voltage domain, wherein the receiver circuit includes a differential envelope detector circuit comprising:
a differential transconductance circuit configured to receive a first voltage signal of a differential signal and a second voltage signal of the differential signal and generate a first output current signal based on the first voltage signal and a second voltage signal,
a common mode detection circuit configured to generate a common mode current signal indicative of common mode noise present in the first voltage signal and the second voltage signal of the differential signal, and
a summation circuit configured to generate a second output current signal by removing the common mode current signal from the first output current signal.

2. The device of claim 1, wherein the first circuit and the second circuit are formed on different circuit dies and the device includes a molding compound formed around the different circuit dies.

3. The device of claim 1, wherein the first circuit and the second circuit are formed on a same circuit die during a semiconductor manufacturing process with a trench formed in the circuit die to isolate the first voltage domain from the second voltage domain, and wherein the device includes a molding compound formed around the circuit die.

4. The device of claim 1, wherein the galvanic isolation barrier is formed via a coreless transformer that galvanically isolates the first voltage domain and the second voltage domain.

5. The device of claim 1, wherein the galvanic isolation barrier is formed via one or more capacitors that galvanically isolates the first voltage domain and the second voltage domain.

6. The device of claim 1, wherein the differential envelope detector circuit further comprises a signal identification circuit configured to determine a high state or a low state associated with the second output current signal.

7. The device of claim 1, wherein the differential transconductance circuit comprises:
a first high side transistor and a second low side transistor configured to receive the first voltage signal of the differential signal; and
a second high side transistor and a first low side transistor configured to receive the second voltage signal of the differential signal, and
wherein the common mode detection circuit comprises a third high side transistor and a third low side transistor both connected to a circuit node that receives both the first voltage signal and the second voltage signal of the differential signal.

8. The device of claim 7, wherein the circuit node is positioned between two resistors that electorally connect to inputs of the first voltage signal and the second voltage signal of the differential signal.

9. The device of claim 7, wherein the summation circuit comprises:
a current mirror circuit configured to generate a mirror of the common mode current signal; and
a capacitor connected to the first output current signal and configured to form a subtraction node that causes the common mode current signal to be removed from the first output current signal and to store an output voltage signal indicative of the second output current signal.

10. The device of claim 7,
wherein the first low side transistor has an inverted input relative to the first high side transistor,
wherein the second low side transistor has an inverted input relative to the second high side transistor, and
wherein the third low side transistor has an inverted input relative to the third high side transistor.

11. The device of claim 10,
wherein an output of the first high side transistor is connected to an input of the first low side transistor,
wherein an output of the second high side transistor is connected to an input of the second low side transistor, and
wherein an output of the third high side transistor is connected to an input of the third low side transistor.

12. A differential envelope detector circuit comprising:
a differential transconductance circuit configured to receive a first voltage signal of a differential signal and a second voltage signal of the differential signal and generate a first output current signal based on the first voltage signal and a second voltage signal,
a common mode detection circuit configured to generate a common mode current signal indicative of common mode noise present in the first voltage signal and the second voltage signal of the differential signal, and
a summation circuit configured to generate a second output current signal by removing the common mode current signal from the first output current signal.

13. The differential envelope detector circuit of claim 12, further comprising a signal identification circuit configured to determine a high state or a low state associated with the second output current signal.

14. The differential envelope detector circuit of claim 12, wherein the differential transconductance circuit comprises:
a first high side transistor and a second low side transistor configured to receive the first voltage signal of the differential signal; and
a second high side transistor and a first low side transistor configured to receive the second voltage signal of the differential signal, and
wherein the common mode detection circuit comprises a third high side transistor and a third low side transistor both connected to a circuit node that receives both the first voltage signal and the second voltage signal of the differential signal.

15. The differential envelope detector circuit of claim 14, wherein the circuit node is positioned between two resistors that electorally connect to inputs of the first voltage signal and the second voltage signal of the differential signal.

16. The differential envelope detector circuit of claim 15, wherein the summation circuit comprises:
a current mirror circuit configured to generate a mirror of the common mode current signal; and
a capacitor connected to the first output current signal and configured to form a subtraction node that causes the common mode current signal to be removed from the first output current signal and to store an output voltage signal indicative of the second output current signal.

17. The differential envelope detector circuit of claim 14,
wherein the first low side transistor has an inverted input relative to the first high side transistor,
wherein the second low side transistor has an inverted input relative to the second high side transistor, and
wherein the third low side transistor has an inverted input relative to the third high side transistor.

18. The differential envelope detector circuit of claim 17,
wherein an output of the first high side transistor is connected to an input of the first low side transistor,
wherein an output of the second high side transistor is connected to an input of the second low side transistor, and
wherein an output of the third high side transistor is connected to an input of the third low side transistor.

19. A method performed by an envelope detector circuit, the method comprising:
receiving, at a differential transconductance circuit, a first voltage signal and a second voltage signal, wherein the first voltage signal and the second voltage signal define a differential signal;
generating, via the differential transconductance circuit, a first output current signal based on the first voltage signal and a second voltage signal;
generating, via a common mode detection circuit, a common mode current signal indicative of common mode noise present in the first voltage signal and the second voltage signal; and
generating, via a summation circuit, a second output current signal by removing the common mode current signal from the first output current signal.

20. The method of claim 19, further comprising:
determining a high state or a low state associated with the second output current signal.
